(19) United States
(12) Patent Application Publication
(10) Pub. No.: US 2008/0225776 A1
(43) Pub. Date: Sep. 18, 2008

(54) Apparatus, methods, and computer program products providing unsolicited HARQ for system information in the downlink

(75) Inventor: Seppo M. Alanara, Oulu (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 12/075,918

(22) Filed: Mar. 14, 2008

Related U.S. Application Data
(60) Provisional application No. 60/918,184, filed on Mar. 14, 2007.

(51) Int. Cl. H04B 3/36

(52) U.S. Cl. 370/315

(57) ABSTRACT

In one non-limiting, exemplary embodiment, incremental HARQ combining is performed in the DL for system information (e.g., the BCCH) without the interactive ACK/NACK responses that are an element of conventional HARQ. Instead, a number of unsolicited HARQ repeats are sent. That is, one or more HARQ incremental repeats of the BCCH frame are sent without any ACK/NACK feedback (e.g., from the UE). In one non-limiting, exemplary embodiment, a method includes: transmitting a system information message from a base station to a user equipment; and retransmitting the system information message as an unsolicited HARQ message from the base station to the user equipment, wherein the unsolicited HARQ message is not triggered by an indication from the user equipment. In further exemplary embodiments, the system information message is retransmitted as the unsolicited HARQ message in order to maintain a target BLER within a coverage area of the base station.

### CROSS-REFERENCE TO RELATED APPLICATIONS

This patent application claims priority under 35 U.S.C. §119(e) from U.S. Provisional Patent Application No. 60/918,184, filed Mar. 14, 2007, the disclosure of which is incorporated by reference herein in its entirety.

### TECHNICAL FIELD

The exemplary and non-limiting embodiments of this invention relate generally to wireless communication systems, apparatus, methods and computer program products and, more specifically, relate to hybrid automatic repeat-requests.

### BACKGROUND

The following abbreviations are utilized herein:
ACK acknowledgement
ARQ automatic repeat-request
BCH broadcast channel
BCCH broadcast control channel
BLER block error rate
CQI channel quality indicator
CRC cyclic redundancy check
D-BCH dynamic broadcast channel
DCCH dedicated control channel
DL downlink (Node B to UE)
DL-SCH downlink shared channel
DTCH dedicated traffic channel
E-UTRAN evolved universal terrestrial radio access network (LTE of UTRAN)
HARQ hybrid automatic repeat-request
L1 layer 1 (physical layer, PHY)
LTE long term evolution of UTRAN (E-UTRAN)
MAC medium access control (layer 2, L2)
MIB master information block
NACK negative acknowledgement
Node B base station
PDCCH physical downlink control channel
RV redundancy version
UE user equipment, such as a mobile station or mobile terminal
UL uplink (UE to Node B)

Consider the currently proposed channel coding of system information in E-UTRAN. One element comprises using the BCCH logical channel, as mapped to the BCH transport channel, to transmit at least a portion of system information. Currently, the transport format is of a fixed, though as yet unspecified (i.e., undetermined), size. The channel coding rate is assumed to be implicitly given by the combination of transport block size, modulation and resource assignment. Furthermore, no BCH HARQ is employed.

HARQ is a scheme for re-transmitting a packet to compensate for an erroneous packet. In particular, HARQ is useful for instances when an error occurs in the reception of an initially transmitted data packet. HARQ functionality helps ensure accurate delivery between peer entities at L1. HARQ uses multiple stop-and-wait processes operating in parallel. For example, for each transport block received in the UL, an acknowledgment is transmitted from the Node B to the UE after the receiver of the Node B performs a CRC to indicate a successful decoding (ACK) or to request a retransmission of the erroneously received transport block (NACK). UL signaling includes the one-bit HARQ positive/negative acknowledgement (HARQ-ACK/NACK), and five-bit measurement report (CQI), as non-limiting examples. At the Node B, the UL signaling information or status report is processed by a MAC sublayer. These ACK/NACK messages are generally transmitted with special physical layer signaling independent of data transmission.

HARQ may also be used in the DL in a similar manner. Currently, E-UTRAN utilizes HARQ in both the UL and DL. As such, for each transport block received in the DL by the UE, a HARQ message (i.e., ACK or NACK) is transmitted from the UE to the Node B. An ACK is signaled after the receiver of the UE performs a CRC that indicates a successful decoding while a NACK comprises a request for retransmission of an erroneously received (e.g., erroneously decoded) transport block.

Reference with regard to E-UTRAN may be made to 3GPP TS 36.300 V1.0.0, “3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2 (Release 8),” March 2007. Specific reference is made to Section 7.4 of TS 36.300 V1.0.0 with regards to system information.

### SUMMARY

In an exemplary embodiment of the invention, a method comprising: transmitting a system information message from a base station to a user equipment; and retransmitting the system information message as an unsolicited hybrid automatic repeat-request (HARQ) message from the base station to the user equipment, wherein the unsolicited HARQ message is not triggered by an indication from the user equipment.

In another exemplary embodiment of the invention, a program storage device readable by a machine, tangibly embodying a program of instructions executable by the machine for performing operations, said operations comprising: transmitting a system information message from a base station to a user equipment; and retransmitting the system information message as an unsolicited hybrid automatic repeat-request (HARQ) message from the base station to the user equipment, wherein the unsolicited HARQ message is not triggered by an indication from the user equipment.

In another exemplary embodiment of the invention, an apparatus comprising: a data processor; and a transmitter configured to transmit a system information message to a user equipment and to retransmit the system information message as an unsolicited hybrid automatic repeat-request (HARQ) message to the user equipment, wherein the unsolicited HARQ message is not triggered by an indication from the user equipment.

In another exemplary embodiment of the invention, an apparatus comprising: means for transmitting a system information message from a base station to a user equipment; and means for retransmitting the system information message as an unsolicited hybrid automatic repeat-request (HARQ) message from the base station to the user equipment, wherein the unsolicited HARQ message is not triggered by an indication from the user equipment.

### BRIEF DESCRIPTION OF THE DRAWINGS

The foregoing and other aspects of exemplary embodiments of this invention are made more evident in the following Detailed Description, when read in conjunction with the attached Drawing Figures, wherein:

FIG. 1 shows a simplified block diagram of various exemplary electronic devices that are suitable for use in practicing the exemplary embodiments of this invention; and

FIGS. 2 and 3 depict flowcharts illustrating two non-limiting examples of methods for practicing the exemplary embodiments of this invention.

### DETAILED DESCRIPTION

The BCH shares the DL capacity with the DL-SCH. As it stands, in E-UTRAN UEs implement the HARQ process for the DL-SCH. Thus, it is possible for the UEs (e.g., receivers) to combine the HARQ repeats incrementally.

Aspects of the exemplary embodiments of the invention improve efficiency, for example, by enabling a receiver to utilize similar (e.g., the same) techniques for BCCH reception as for DL-SCH reception, such as for DCCH and/or DTCH, as non-limiting examples.

In one non-limiting, exemplary embodiment, incremental HARQ combining is performed in the DL for system information (e.g., the BCCH) without the interactive ACK/NACK responses that form a key element in conventional HARQ. Instead, a number of unsolicited HARQ repeats are sent. That is, one or more HARQ incremental repeats of the BCCH frame are sent without any ACK/NACK feedback.

In other exemplary embodiments, the incremental soft combining algorithms available in the UE can be utilized. In further exemplary embodiments, it may be preferable to determine or set a target BLER and subsequently estimate the number of HARQ repeats that should be sent in order to ensure the target BLER for the BCCH in the service area (e.g., in the whole service area). These values may be obtained by running simulations, for example. In other exemplary embodiments, any suitable number of HARQ repeats may be employed. In further exemplary embodiments, the number of HARQ repeats comprises a preset value. In other exemplary embodiments, the number of HARQ repeats is based on one or more measurements performed by the UE and/or Node B. as non-limiting examples. As non-limiting examples, the HARQ may be based on a measured or determined BLER.

In further exemplary embodiments, the HARQ repeats are sent within a relatively short time period following the initial transmission of that frame. In other exemplary embodiments, the unsolicited HARQ repeat system may be utilized in conjunction with the conventional ACK/NACK HARQ functionality. As a non-limiting example, a certain number of HARQ repeats may be sent after which, unless an ACK or NACK message (as specified by the parameters of the system) is received, no additional HARQ repeats are transmitted. As a further non-limiting example, a certain number of HARQ repeats may be sent. In response to receiving an ACK or NACK message (as specified by the parameters of the system) immediately thereafter, one or more additional HARQ repeats may be sent.

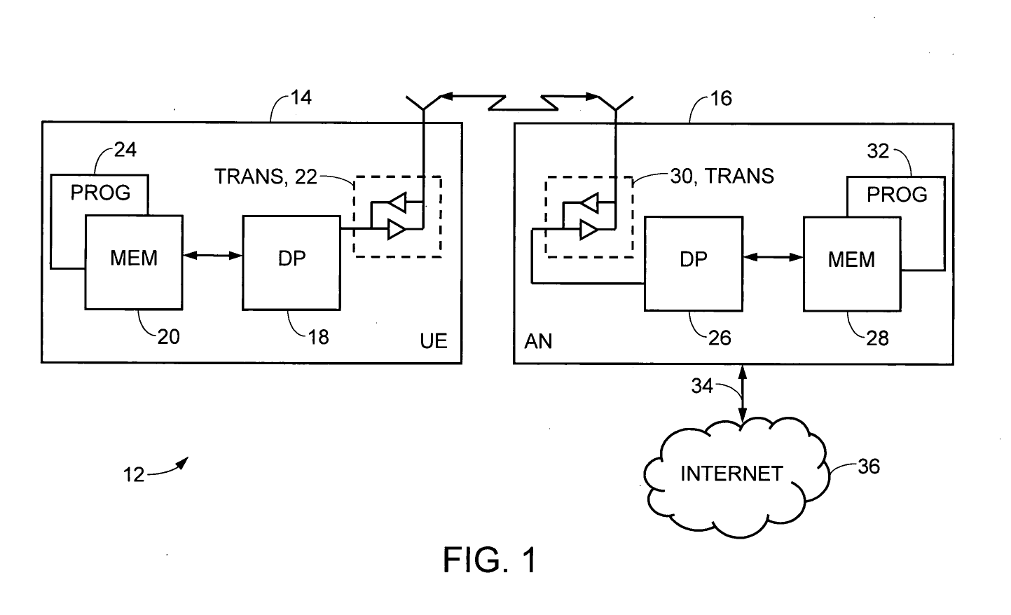

Reference is made to FIG. 1 for illustrating a simplified block diagram of various exemplary electronic devices that are suitable for use in practicing the exemplary embodiments of this invention. In FIG. 1, a wireless network 12 is adapted for communication with a user equipment (UE) 14 via an access node (AN) 16. The UE 14 includes a data processor (DP) 18, a memory (MEM) 20 coupled to the DP 18, and a suitable RF transceiver (TRANS) 22 (having a transmitter (TX) and a receiver (RX)) coupled to the DP 18. The MEM 20 stores a program (PROG) 24. The TRANS 22 is for bidirectional wireless communications with the AN 16. Note that the TRANS 22 has at least one antenna to facilitate communication.

The AN 16 includes a data processor (DP) 26, a memory (MEM) 28 coupled to the DP 26, and a suitable RF transceiver (TRANS) 30 (having a transmitter (TX) and a receiver (RX)) coupled to the DP 26. The MEM 28 stores a program (PROG) 32. The TRANS 30 is for bidirectional wireless communications with the UE 14. Note that the TRANS 30 has at least one antenna to facilitate communication. The AN 16 is coupled via a data path 34 to one or more external networks or systems, such as the internet 36, for example.

At least one of the PROGs 24, 32 is assumed to include program instructions that, when executed by the associated DP, enable the electronic device to operate in accordance with the exemplary embodiments of this invention, as discussed herein.

In general, the various embodiments of the UE 14 can include, but are not limited to, mobile stations, mobile terminals, mobile phones, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by one or more of the DPs 18, 26 of the UE 14 and the AN 16, or by hardware, or by a combination of software and hardware.

The MEMs 20, 28 may be of any type suitable to the local technical environment and may be implemented using any suitable data storage technology, such as semiconductor-based memory devices, magnetic memory devices and systems, optical memory devices and systems, fixed memory and removable memory, as non-limiting examples. The DPs 18, 26 may be of any type suitable to the local technical environment, and may include one or more of general purpose computers, special purpose computers, microprocessors, digital signal processors (DSPs) and processors based on a multi-core processor architecture, as non-limiting examples.

As can be seen, the exemplary embodiments of the invention enable incremental HARQ combining in the DL for system information (e.g., the BCH) utilizing unsolicited HARQ (e.g., HARQ repeats) instead of, or in addition to, conventional interactive ACK/NACK responses.

Below are provided further descriptions of non-limiting, exemplary embodiments of the invention. The below-described exemplary embodiments are separately numbered for clarity and identification. This numbering should not be construed as wholly separating the below descriptions since various aspects of one or more exemplary embodiments may be practiced in conjunction with one or more other aspects or exemplary embodiments.

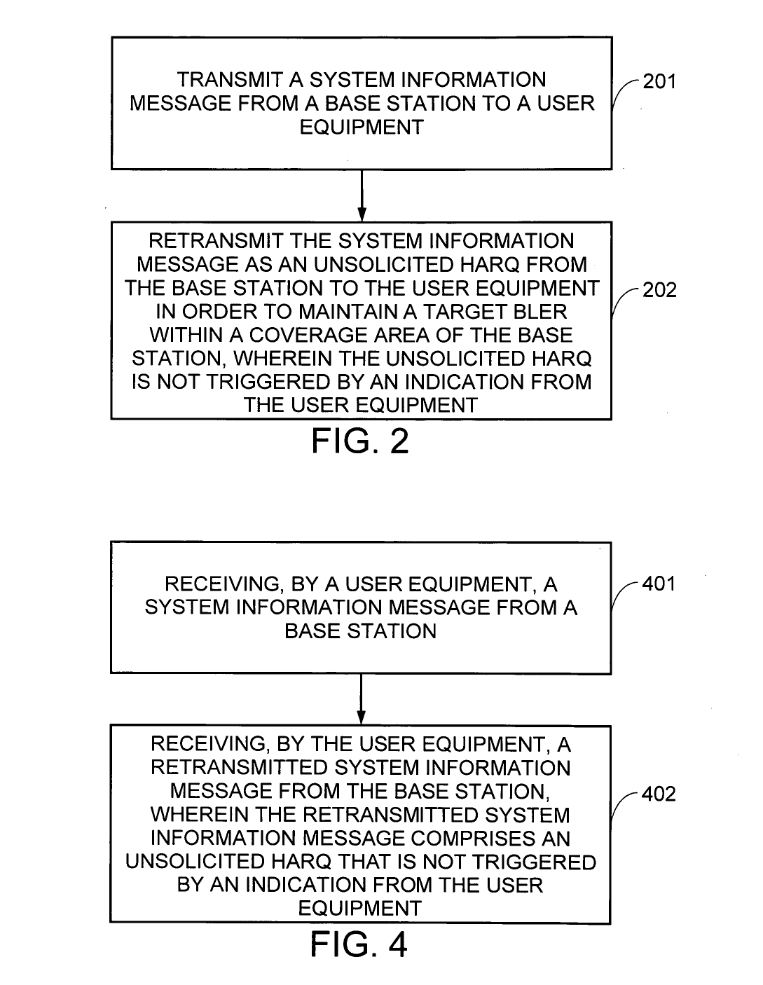

(1) In one non-limiting, exemplary embodiment, and as illustrated in FIG. 2, a method comprising: transmitting a system information message from a base station to a user equipment (201); and retransmitting the system information message as an unsolicited hybrid automatic repeat-request (HARQ) message from the base station to the user equipment, wherein the unsolicited HARQ message is not triggered by an indication from the user equipment (202).

A method as above, wherein the system information message is retransmitted as the unsolicited HARQ message in order to maintain a target block error rate (BLER) within a coverage area of the base station. A method as in the previous, further comprising: estimating a number of HARQ repeats that are to be sent in order to ensure the target BLER for the coverage area. A method as in any above, wherein the system information message comprises at least one broadcast control channel frame. A method as in any above, wherein the system information message is transmitted via a dynamic broadcast channel or a downlink shared channel.

A method as in any above, wherein the system information message is retransmitted as the unsolicited HARQ message n times, wherein n comprises an integer. A method as in any above, wherein n comprises a predetermined value. A method as in any above, wherein a value of n is based on at least one measurement performed by the user equipment or the base station. A method as in any above, wherein a value of n is based on a determined block error rate.

A method as in any above, wherein retransmission of the system information message as the unsolicited HARQ message occurs within a relatively short time period following the initial transmission of the system information message. A method as in any above, further comprising: receiving an acknowledgement or negative acknowledgement from the user equipment in response to transmission of the system information message or retransmission of the system information message as the unsolicited HARQ message. A method as in any above, wherein the base station and the user equipment comprise nodes of an evolved universal terrestrial radio access network. A method as in any above, wherein the method is implemented by a computer program.

A method as in any above, further comprising: transmitting a HARQ indication from the base station to the user equipment, wherein the HARQ indication is indicative that unsolicited HARQ is in use by the base station. A method as in any above, wherein the system information message comprises the HARQ indication. A method as in any above, wherein a master information block (MIB) comprises the HARQ indication. A method as in any above, wherein a transmission on a physical downlink control channel (PDCCH) comprises the HARQ indication. A method as in any above, wherein the HARQ indication comprises a dedicated value of redundancy version (RV). A method as in any above, wherein the HARQ indication comprises a HARQ process identification.

(2) In another non-limiting, exemplary embodiment of the invention, a program storage device readable by a machine, tangibly embodying a program of instructions executable by the machine for performing operations, said operations comprising: transmitting a system information message from a base station to a user equipment; and retransmitting the system information message as an unsolicited hybrid automatic repeat-request (HARQ) message from the base station to the user equipment, wherein the unsolicited HARQ message is not triggered by an indication from the user equipment.

A program storage device as above, wherein the system information message is retransmitted as the unsolicited HARQ message in order to maintain a target block error rate (BLER) within a coverage area of the base station. A program storage device as in the previous, said operations further comprising: estimating a number of HARQ repeats that are to be sent in order to ensure the target BLER for the coverage area. A program storage device as in any above, wherein the system information message comprises at least one broadcast control channel frame. A program storage device as in any above, wherein the system information message is transmitted via a dynamic broadcast channel or a downlink shared channel.

A program storage device as in any above, wherein the system information message is retransmitted as the unsolicited HARQ message n times, wherein n comprises an integer. A program storage device as in any above, wherein n comprises a predetermined value. A program storage device as in any above, wherein a value of n is based on at least one measurement performed by the user equipment or the base station. A program storage device as in any above, wherein a value of n is based on a determined block error rate.

A program storage device as in any above, wherein retransmission of the system information message as the unsolicited HARQ message occurs within a relatively short time period following the initial transmission of the system information message. A program storage device as in any above, said operations further comprising: receiving an acknowledgement or negative acknowledgement from the user equipment in response to transmission of the system information message or retransmission of the system information message as the unsolicited HARQ message. A program storage device as in any above, wherein the base station and the user equipment comprise nodes of an evolved universal terrestrial radio access network.

A program storage device as in any above, said operations further comprising: transmitting a HARQ indication from the base station to the user equipment, wherein the indication is indicative that unsolicited HARQ is in use by the base station. A program storage device as in any above, wherein the system information message comprises the HARQ indication. A program storage device as in any above, wherein a master information block (MIB) comprises the HARQ indication. A program storage device as in any above, wherein a transmission on a physical downlink control channel (PDCCH) comprises the HARQ indication. A program storage device as in any above, wherein the HARQ indication comprises a dedicated value of redundancy version (RV). A program storage device as in any above, wherein the HARQ indication comprises a HARQ process identification. A program storage device as in any above, wherein the machine comprises the base station.

(3) In another non-limiting, exemplary embodiment, an apparatus comprising: a data processor; and a transmitter coupled to the data processor, wherein the transmitter is configured to transmit a system information message to a user equipment and to retransmit the system information message as an unsolicited hybrid automatic repeat-request (HARQ) message to the user equipment, wherein the unsolicited HARQ is not triggered by an indication from the user equipment.

An apparatus as above, wherein the system information message is retransmitted as the unsolicited HARQ message in order to maintain a target block error rate (BLER) within a coverage area of the apparatus. An apparatus as in the previous, wherein the data processor is configured to estimate a number of HARQ repeats that are to be sent in order to ensure the target BLER for the coverage area. An apparatus as in any above, wherein the system information message comprises at least one broadcast control channel frame. An apparatus as in any above, wherein the system information message is transmitted via a dynamic broadcast channel or a downlink shared channel.

An apparatus as in any above, wherein the system information message is retransmitted as the unsolicited HARQ message n times, wherein n comprises an integer. An apparatus as in any above, wherein n comprises a predetermined value. An apparatus as in any above, wherein a value of n is based on at least one measurement performed by the user equipment or the apparatus. An apparatus as in any above, wherein a value of n is based on a determined block error rate.

An apparatus as in any above, wherein retransmission of the system information message as the unsolicited HARQ message occurs within a relatively short time period following the initial transmission of the system information message. An apparatus as in any above, further comprising a receiver configured to receive an acknowledgement or negative acknowledgement from the user equipment in response to transmission of the system information message or retransmission of the system information message as the unsolicited HARQ message. An apparatus as in any above, wherein the apparatus and the user equipment comprise nodes of an evolved universal terrestrial radio access network. An apparatus as in any above, wherein the apparatus comprises a base station.

An apparatus as in any above, wherein the transmitter is further configured to transmit a HARQ indication from the apparatus to the user equipment, wherein the HARQ indication is indicative that unsolicited HARQ is in use by the apparatus. An apparatus as in any above, wherein the system information message comprises the HARQ indication. An apparatus as in any above, wherein a master information block (MIB) comprises the HARQ indication. An apparatus as in any above, wherein a transmission on a physical downlink control channel (PDCCH) comprises the HARQ indication. An apparatus as in any above, wherein the HARQ indication comprises a dedicated value of redundancy version (RV). An apparatus as in any above, wherein the HARQ indication comprises a HARQ process identification.

(4) In another exemplary embodiment of the invention, an apparatus comprising: means for transmitting a system information message from a base station to a user equipment; and means for retransmitting the system information message as an unsolicited hybrid automatic repeat-request (HARQ) message from the base station to the user equipment, wherein the unsolicited HARQ message is not triggered by an indication from the user equipment.

An apparatus as above, wherein the system information message is retransmitted as the unsolicited HARQ message in order to maintain a target block error rate (BLER) within a coverage area of the apparatus. An apparatus as in the previous, further comprising: means for estimating a number of HARQ repeats that are to be sent in order to ensure the target BLER for the coverage area. An apparatus as in any above, wherein the means for estimating comprises a processor. An apparatus as in any above, wherein the system information message comprises at least one broadcast control channel frame. An apparatus as in any above, wherein the system information message is transmitted via a dynamic broadcast channel or a downlink shared channel.

An apparatus as in any above, wherein the system information message is retransmitted as the unsolicited HARQ message n times, wherein n comprises an integer. An apparatus as in any above, wherein n comprises a predetermined value. An apparatus as in any above, wherein a value of n is based on at least one measurement performed by the user equipment or the apparatus. An apparatus as in any above, wherein a value of n is based on a determined block error rate.

An apparatus as in any above, wherein retransmission of the system information message as the unsolicited HARQ message occurs within a relatively short time period following the initial transmission of the system information message. An apparatus as in any above, further comprising: means for receiving an acknowledgement or negative acknowledgement from the user equipment in response to transmission of the system information message or retransmission of the system information message as the unsolicited HARQ message. An apparatus as in any above, wherein the apparatus and the user equipment comprise nodes of an evolved universal terrestrial radio access network. An apparatus as in any above, wherein the apparatus comprises a base station. An apparatus as in any above, wherein the means for transmitting and the means for retransmitting comprise a transmitter or a transceiver. An apparatus as in any above, further comprising means for processing. An apparatus as in any above, wherein the means for processing comprises a processor.

An apparatus as in any above, further comprising: means for transmitting a HARQ indication from the base station to the user equipment, wherein the HARQ indication is indicative that unsolicited HARQ is in use by the apparatus. An apparatus as in any above, wherein the system information message comprises the HARQ indication. An apparatus as in any above, wherein a master information block (MIB) comprises the HARQ indication. An apparatus as in any above, wherein a transmission on a physical downlink control channel (PDCCH) comprises the HARQ indication. An apparatus as in any above, wherein the HARQ indication comprises a dedicated value of redundancy version (RV). An apparatus as in any above, wherein the HARQ indication comprises a HARQ process identification. An apparatus as in any above, wherein the means for transmitting the HARQ indication comprises a transmitter or a transceiver.

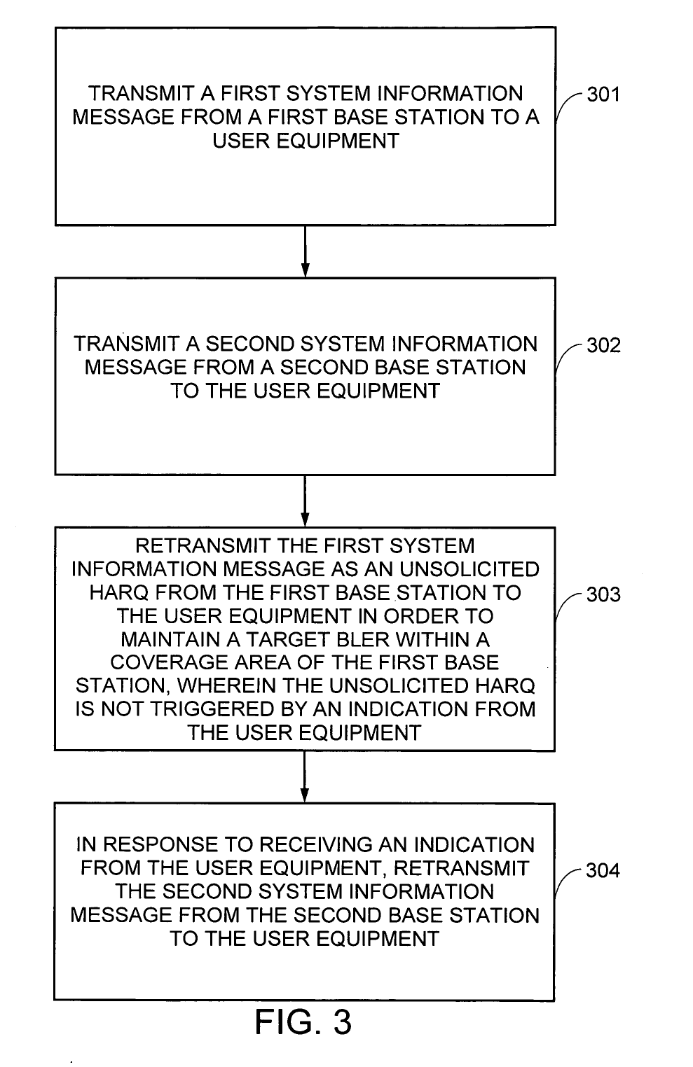

(5) In another non-limiting, exemplary embodiment, and as illustrated in FIG. 3, a method comprising: transmitting a first system information message from a first base station to a user equipment (301); transmitting a second system information message from a second base station to the user equipment (302); retransmitting the first system information message as an unsolicited HARQ message from the first base station to the user equipment in order to maintain a target BLER within a coverage area of the first base station, wherein the unsolicited HARQ message is not triggered by an indication from the user equipment (303); and, in response to receiving an indication from the user equipment, retransmitting the second system information message from the second base station to the user equipment (304).

A method as above, wherein the first system information message is retransmitted as the unsolicited HARQ message in order to maintain a target block error rate (BLER) within a coverage area of the first base station. A method as in the previous, further comprising: estimating a number of HARQ repeats that are to be sent in order to ensure the target BLER for the coverage area of the first base station. A method as in any above, wherein the first system information message comprises at least one broadcast control channel frame. A method as in any above, wherein the first system information message is transmitted via a dynamic broadcast channel or a downlink shared channel.

A method as in any above, wherein the first system information message is retransmitted as the unsolicited HARQ message n times, wherein n comprises an integer. A method as in any above, wherein n comprises a predetermined value. A method as in any above, wherein a value of n is based on at least one measurement performed by the user equipment or the first base station. A method as in any above, wherein a value of n is based on a determined block error rate.

A method as in any above, wherein retransmission of the first system information message as the unsolicited HARQ message occurs within a relatively short time period following the initial transmission of the first system information message. A method as in any above, further comprising: receiving, by the first base station, an acknowledgement or negative acknowledgement from the user equipment in response to transmission of the first system information message or retransmission of the first system information message as the unsolicited HARQ message. A method as in any above, wherein at least the first base station and the user equipment comprise nodes of an evolved universal terrestrial radio access network. A method as in any above, wherein the method is implemented by a computer program.

A method as in any above, further comprising: transmitting a HARQ indication from the first base station to the user equipment, wherein the HARQ indication is indicative that unsolicited HARQ is in use by the first base station. A method as in any above, wherein the first system information message comprises the HARQ indication. A method as in any above, wherein a master information block (MIB) comprises the HARQ indication. A method as in any above, wherein a transmission on a physical downlink control channel (PDCCH) comprises the HARQ indication. A method as in any above, wherein the HARQ indication comprises a dedicated value of redundancy version (RV). A method as in any above, wherein the HARQ indication comprises a HARQ process identification.

(6) In another non-limiting, exemplary embodiment, and as depicted in FIG. 4, a method comprising: receiving, by a user equipment, a system information message from a base station (401); and receiving, by the user equipment, a retransmitted system information message from the base station, wherein the retransmitted system information message comprises an unsolicited HARQ message that is not triggered by an indication from the user equipment (402).

A method as in any above, wherein the system information message (and/or the retransmitted system information message) comprises at least one broadcast control channel frame. A method as in any above, wherein the system information message (and/or the retransmitted system information message) is received via a dynamic broadcast channel or a downlink shared channel. A method as in any above, wherein the retransmitted system information message is received as an unsolicited HARQ message n times, wherein n comprises an integer. A method as in any above, wherein n comprises a predetermined value. A method as in any above, wherein a value of n is based on at least one measurement performed by the user equipment or the base station. A method as in any above, wherein a value of n is based on a determined block error rate.

A method as in any above, wherein reception of the retransmitted system information message as the unsolicited HARQ message occurs within a relatively short time period following the initial reception of the system information message. A method as in any above, further comprising: transmitting an acknowledgement or negative acknowledgement in response to reception of the system information message or the retransmitted system information message as the unsolicited HARQ message. A method as in any above, wherein the base station and/or the user equipment comprise nodes of an evolved universal terrestrial radio access network. A method as in any above, wherein the method is implemented by a computer program.

A method as in any above, further comprising: receiving a HARQ indication from the base station, wherein the HARQ indication is indicative that unsolicited HARQ is in use by the base station. A method as in any above, wherein the system information message comprises the HARQ indication. A method as in any above, wherein a master information block (MIB) comprises the HARQ indication. A method as in any above, wherein a transmission on a physical downlink control channel (PDCCH) comprises the HARQ indication. A method as in any above, wherein the HARQ indication comprises a dedicated value of redundancy version (RV). A method as in any above, wherein the HARQ indication comprises a HARQ process identification.

(7) In another non-limiting, exemplary embodiment, a program storage device readable by a machine, tangibly embodying a program of instructions executable by the machine for performing operations, said operations comprising: receiving, by a user equipment, a system information message from a base station (401); and receiving, by the user equipment, a retransmitted system information message from the base station, wherein the retransmitted system information message comprises an unsolicited HARQ message that is not triggered by an indication from the user equipment (402).

A program storage device as in any above, wherein the system information message (and/or the retransmitted system information message) comprises at least one broadcast control channel frame. A program storage device as in any above, wherein the system information message (and/or the retransmitted system information message) is received via a dynamic broadcast channel or a downlink shared channel. A program storage device as in any above, wherein the retransmitted system information message is received as an unsolicited HARQ message n times, wherein n comprises an integer. A program storage device as in any above, wherein n comprises a predetermined value. A program storage device as in any above, wherein a value of n is based on at least one measurement performed by the user equipment or the base station. A program storage device as in any above, wherein a value of n is based on a determined block error rate.

A program storage device as in any above, wherein reception of the retransmitted system information message as the unsolicited HARQ message occurs within a relatively short time period following the initial reception of the system information message. A program storage device as in any above, said operations further comprising: transmitting an acknowledgement or negative acknowledgement in response to reception of the system information message or the retransmitted system information message as the unsolicited HARQ message. A program storage device as in any above, wherein the base station and/or the user equipment comprise nodes of an evolved universal terrestrial radio access network.

A program storage device as in any above, said operations further comprising: receiving a HARQ indication from the base station, wherein the HARQ indication is indicative that unsolicited HARQ is in use by the base station. A program storage device as in any above, wherein the system information message comprises the HARQ indication. A program storage device as in any above, wherein a master information block (MIB) comprises the HARQ indication. A program storage device as in any above, wherein a transmission on a physical downlink control channel (PDCCH) comprises the HARQ indication. A program storage device as in any above, wherein the HARQ indication comprises a dedicated value of redundancy version (RV). A program storage device as in any above, wherein the HARQ indication comprises a HARQ process identification. A program storage device as in any above, wherein the machine comprises the user equipment.

(8) In another non-limiting, exemplary embodiment, an apparatus comprising: a data processor; and a receiver coupled to the data processor, wherein the receiver is configured to receive a system information message from a base station and to receive a retransmitted system information message from the base station, wherein the retransmitted system information message comprises an unsolicited HARQ message that is not triggered by an indication from the apparatus.

An apparatus as above, wherein the system information message (and/or the retransmitted system information message) comprises at least one broadcast control channel frame. An apparatus as in any above, wherein the system information message (and/or the retransmitted system information message) is received via a dynamic broadcast channel or a downlink shared channel. An apparatus as in any above, wherein the retransmitted system information message is received as an unsolicited HARQ message n times, wherein n comprises an integer. An apparatus as in any above, wherein n comprises a predetermined value. An apparatus as in any above, wherein a value of n is based on at least one measurement performed by the apparatus or the base station. An apparatus as in any above, wherein a value of n is based on a determined block error rate.

An apparatus as in any above, wherein reception of the retransmitted system information message as the unsolicited HARQ message occurs within a relatively short time period following the initial reception of the system information message. An apparatus as in any above, further comprising: a transmitter configured to transmit an acknowledgement or negative acknowledgement in response to the receiver receiving the system information message or the retransmitted system information message as the unsolicited HARQ message. An apparatus as in any above, wherein the base station and/or the apparatus comprise nodes of an evolved universal terrestrial radio access network.

An apparatus as in any above, wherein the receiver is further configured to receive a HARQ indication from the base station, wherein the HARQ indication is indicative that unsolicited HARQ is in use by the base station. An apparatus as in any above, wherein the system information message comprises the HARQ indication. An apparatus as in any above, wherein a master information block (MIB) comprises the HARQ indication. An apparatus as in any above, wherein a transmission on a physical downlink control channel (PDCCH) comprises the HARQ indication. An apparatus as in any above, wherein the HARQ indication comprises a dedicated value of redundancy version (RV). An apparatus as in any above, wherein the HARQ indication comprises a HARQ process identification.

An apparatus as in any above, wherein the apparatus comprises a user equipment, a mobile station, a mobile terminal, a mobile phone, a cellular phone, a personal digital assistant (PDA) having wireless communication capabilities, a portable computer having wireless communication capabilities, an image capture device such as a digital camera having wireless communication capabilities, a gaming device having wireless communication capabilities, a music storage and playback appliance having wireless communication capabilities, an Internet appliance permitting wireless Internet access and browsing, or a portable unit or terminal that incorporates combinations of such functions.

(9) In another non-limiting, exemplary embodiment, an apparatus comprising: means for receiving a system information message from a base station (401); and means for receiving a retransmitted system information message from the base station, wherein the retransmitted system information message comprises an unsolicited HARQ that is not triggered by an indication from the user equipment (402).

An apparatus as above, wherein the system information message (and/or the retransmitted system information message) comprises at least one broadcast control channel frame. An apparatus as in any above, wherein the system information message (and/or the retransmitted system information message) is received via a dynamic broadcast channel or a downlink shared channel. An apparatus as in any above, wherein the retransmitted system information message is received as an unsolicited HARQ message n times, wherein n comprises an integer. An apparatus as in any above, wherein n comprises a predetermined value. An apparatus as in any above, wherein a value of n is based on at least one measurement performed by the apparatus or the base station. An apparatus as in any above, wherein a value of n is based on a determined block error rate.

An apparatus as in any above, wherein reception of the retransmitted system information message as the unsolicited HARQ message occurs within a relatively short time period following the initial reception of the system information message. An apparatus as in any above, further comprising: means for transmitting an acknowledgement or negative acknowledgement in response to reception of the system information message or the retransmitted system information message as the unsolicited HARQ message. An apparatus as in any above, wherein the base station and/or the apparatus comprise nodes of an evolved universal terrestrial radio access network. An apparatus as in any above, wherein the means for receiving the system information message and the means for receiving the retransmitted system information message comprise a receiver or a transceiver. An apparatus as in any above, further comprising means for processing. An apparatus as in any above, wherein the means for processing comprises a processor (or a data processor).

An apparatus as in any above, further comprising: means for receiving a HARQ indication from the base station, wherein the HARQ indication is indicative that unsolicited HARQ is in use by the base station. An apparatus as in any above, wherein the system information message comprises the HARQ indication. An apparatus as in any above, wherein a master information block (MIB) comprises the HARQ indication. An apparatus as in any above, wherein a transmission on a physical downlink control channel (PDCCH) comprises the HARQ indication. An apparatus as in any above, wherein the HARQ indication comprises a dedicated value of redundancy version (RV). An apparatus as in any above, wherein the HARQ indication comprises a HARQ process identification. An apparatus as in any above, wherein the means for receiving the HARQ indication comprises a receiver or a transceiver.

An apparatus as in any above, wherein the apparatus comprises a user equipment, a mobile station, a mobile terminal, a mobile phone, a cellular phone, a personal digital assistant (PDA) having wireless communication capabilities, a portable computer having wireless communication capabilities, an image capture device such as a digital camera having wireless communication capabilities, a gaming device having wireless communication capabilities, a music storage and playback appliance having wireless communication capabilities, an Internet appliance permitting wireless Internet access and browsing, or a portable unit or terminal that incorporates combinations of such functions.

The exemplary embodiments of the invention, as discussed above and as particularly described with respect to exemplary methods, may be implemented as a computer program product comprising program instructions embodied on a tangible computer-readable medium. Execution of the program instructions results in operations comprising steps of utilizing the exemplary embodiments or steps of the method.

The exemplary embodiments of the invention, as discussed above and as particularly described with respect to exemplary methods, may be implemented in conjunction with a program storage device readable by a machine, tangibly embodying a program of instructions executable by the machine for performing operations. The operations comprise steps of utilizing the exemplary embodiments or steps of the method.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples. Note that as utilized herein, a system information message may be considered to comprise or further correspond to a system information block or any other message portion or entire message that comprises similar or corresponding system information.

While the exemplary embodiments have been described above in the context of the E-UTRAN (UTRAN-LTE) system, it should be appreciated that the exemplary embodiments of this invention are not limited for use with only this one particular type of wireless communication system, and that they may be used to advantage in other wireless communication systems.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The exemplary embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of the non-limiting and exemplary embodiments of this invention.

Furthermore, some of the features of the preferred embodiments of this invention could be used to advantage without the corresponding use of other features. As such, the foregoing description should be considered as merely illustrative of the principles, teachings and exemplary embodiments of this invention, and not in limitation thereof.

What is claimed is:

1. A method comprising:
transmitting a system information message from a base station to a user equipment; and
retransmitting the system information message as an unsolicited hybrid automatic repeat-request (HARQ) message from the base station to the user equipment, wherein the unsolicited HARQ message is not triggered by an indication from the user equipment.

2. A method as in claim 1, wherein the system information message is retransmitted as the unsolicited HARQ message in order to maintain a target block error rate (BLER) within a coverage area of the base station.

3. A method as in claim 2, further comprising: estimating a number of HARQ repeats that are to be sent in order to ensure the target BLER for the coverage area.

4. A method as in claim 1, wherein the system information message comprises at least one broadcast control channel frame.

5. A method as in claim 1, wherein the system information message is transmitted via a dynamic broadcast channel or a downlink shared channel.

6. A method as in claim 1, wherein the system information message is retransmitted as the unsolicited HARQ message n times, wherein n comprises an integer.

7. A method as in claim 1, further comprising: receiving an acknowledgement or negative acknowledgement from the user equipment in response to transmission of the system information message or retransmission of the system information message as the unsolicited HARQ message.

8. A method as in claim 1, further comprising: transmitting a HARQ indication from the base station to the user equipment, wherein the HARQ indication is indicative that an unsolicited HARQ technique is being used by the base station.

9. A method as in claim 1, wherein the base station and the user equipment comprise nodes of an evolved universal terrestrial radio access network.

10. A program storage device readable by a machine, tangibly embodying a program of instructions executable by the machine for performing operations, said operations comprising:
transmitting a system information message from a base station to a user equipment; and
retransmitting the system information message as an unsolicited hybrid automatic repeat-request (HARQ) message from the base station to the user equipment, wherein the unsolicited HARQ message is not triggered by an indication from the user equipment.

11. A program storage device as in claim 10, wherein the system information message is retransmitted as the unsolicited HARQ message in order to maintain a target block error rate (BLER) within a coverage area of the base station.

12. A program storage device as in claim 11, said operations further comprising: estimating a number of HARQ repeats that are to be sent in order to ensure the target BLER for the coverage area.

13. A program storage device as in claim 10, wherein the system information message comprises at least one broadcast control channel frame.

14. A program storage device as in claim 10, wherein the system information message is transmitted via a dynamic broadcast channel or a downlink shared channel.

15. A program storage device as in claim 10, wherein the system information message is retransmitted as the unsolicited HARQ message n times, wherein n comprises an integer.

16. A program storage device as in claim 10, said operations further comprising: receiving an acknowledgement or negative acknowledgement from the user equipment in response to transmission of the system information message or retransmission of the system information message as the unsolicited HARQ message.

17. A program storage device as in claim 10, said operations further comprising: transmitting a HARQ indication from the base station to the user equipment, wherein the HARQ indication is indicative that unsolicited HARQ is in use by the base station.

18. A program storage device as in claim 10, wherein the base station and the user equipment comprise nodes of an evolved universal terrestrial radio access network.

19. A program storage device as in claim 10, wherein the machine comprises the user equipment.

20. An apparatus comprising:
a data processor; and
a transmitter configured to transmit a system information message to a user equipment and to retransmit the system information message as an unsolicited hybrid automatic repeat-request (HARQ) message to the user equipment, wherein the unsolicited HARQ message is not triggered by an indication from the user equipment.

21. An apparatus as in claim 20, wherein the system information message is retransmitted as the unsolicited HARQ message in order to maintain a target block error rate (BLER) within a coverage area of the apparatus.

22. An apparatus as in claim 21, wherein the data processor is configured to estimate a number of HARQ repeats that are to be sent via the transmitter in order to ensure the target BLER for the coverage area.

23. An apparatus as in claim 20, wherein the system information message comprises at least one broadcast control channel frame.

24. An apparatus as in claim 20, wherein the system information message is transmitted via a dynamic broadcast channel or a downlink shared channel.

25. An apparatus as in claim 20, wherein the system information message is retransmitted as the unsolicited HARQ message n times, wherein n comprises an integer.

26. An apparatus as in claim 20, further comprising: a receiver configured to receive an acknowledgement or negative acknowledgement from the user equipment in response to transmission of the system information message or retransmission of the system information message as the unsolicited HARQ message.

27. An apparatus as in claim 20, wherein the transmitter is further configured to transmit a HARQ indication from the base station to the user equipment, wherein the HARQ indication is indicative that unsolicited HARQ is in use by the apparatus.

28. An apparatus as in claim 20, wherein the apparatus comprises a base station.

29. An apparatus as in claim 28, wherein the base station comprises a node of an evolved universal terrestrial radio access network.

30. An apparatus comprising:
means for transmitting a system information message to a user equipment; and
means for retransmitting the system information message as an unsolicited hybrid automatic repeat-request (HARQ) message to the user equipment, wherein the unsolicited HARQ message is not triggered by an indication from the user equipment.

31. An apparatus as in claim 30, wherein the system information message is retransmitted as the unsolicited HARQ message in order to maintain a target block error rate (BLER) within a coverage area of the apparatus.

32. An apparatus as in claim 30, further comprising means for processing, wherein the means for processing comprises a processor, wherein the means for transmitting and the means for retransmitting comprise a transmitter or a transceiver.

33. An apparatus as in claim 30, wherein the apparatus comprises a base station.

34. An apparatus as in claim 33, wherein the base station comprises a node of an evolved universal terrestrial radio access network.
